(19) United States
(12) Patent Application Publication
(10) Pub. No.: US 2025/0348713 A1
(43) Pub. Date: Nov. 13, 2025

(54) GENERATIVE ARTIFICIAL INTELLIGENCE BASED ADAPTIVE TRAINING

(71) Applicant: Vanderbilt University, Nashville, TN (US)

(72) Inventors: Allen Brady Karns, Nashville, TN (US); Jules White, Nashville, TN (US)

(21) Appl. No.: 18/786,951

(22) Filed: Jul. 29, 2024

Related U.S. Application Data
(60) Provisional application No. 63/644,024, filed on May 8, 2024.

(51) Int. Cl. G06N 3/0475; G06N 5/02

(52) U.S. Cl. CPC G06N 3/0475; G06N 5/02

(57) ABSTRACT

A system for generative artificial intelligence based adaptive training. The system includes an electronic processor. The electronic processor is configured to receive a prompt to generate a virtual training assistant, the prompt including a description of one or more training aids and a format for responses corresponding to the one or more training aids. The electronic processor is also configured to retrieve, using a retrieval model, personnel information from a personnel database, retrieve, using the retrieval model, knowledge information corresponding to the personnel information from a knowledge database, and augment the prompt to include a compliance rule regulating responses of the virtual training assistant. The electronic processor is also configured to generate, using a generator model, the virtual training assistant based on the prompt and configured to generate responses corresponding to the personnel information, the knowledge information, the responses being in compliance with the compliance rule.

### CROSS-REFERENCE TO RELATED APPLICATION

This application claims priority to U.S. Provisional Application No. 63/644,024, filed May 8, 2024, which is hereby incorporated by reference in its entirety.

### FIELD

The present application relates to the field of generative artificial intelligence (AI) driven learning and training solutions.

### SUMMARY

Many employees, students, and other individuals are required to or desire to complete training or learning courses for their job or education or to achieve a certification (for example, passing a written portion of a driver's test). Current training methods include traditional in-person training sessions, static online courses and eLearning modules, and periodic compliance testing. For example, companies often conduct periodic classroom-style training sessions to educate employees on compliance, policies, and best practices. However, classroom style training sessions can be time-consuming and difficult to scale. In another example, many organizations provide pre-recorded training content for employees to complete. While convenient, pre-recorded training content lacks personalization and interactivity. In yet another example, companies may administer periodic assessments to check employee knowledge. However, such assessments are often disconnected from practical application.

Therefore, there exists a need for systems and methods that provide training that is scalable, engaging, efficient, and effectively measures a trainee's knowledge. Thus, systems and methods described herein provide a customized training experience in accordance with compliance standards by utilizing an adaptive generative AI assistant (also referred to herein as a “virtual training assistant” and an “assistant”) with an integrated knowledge base (for example, the knowledge database described below).

The benefits provided by the virtual training assistant include personalized and adaptive training; continuous, real-world integration; comprehensive compliance coverage; interactive and engaging training; centralized progress tracking and reporting; and agile updates and versioning.

For example, the virtual training assistant may tailor the content, pace, and delivery of training material to each individual user's needs and learning style, improving engagement and knowledge retention. In another example, using feedback on employee performance and real-world incidents, the virtual training assistant may dynamically update the training it provides to address gaps and weaknesses. In some implementations, the virtual training assistant may be configured to cover a wide range of compliance domains, ensuring consistent training across an organization. In some implementations, the virtual training assistant provides a conversational interface and utilizes built-in tools like simulations and assessments to create a more immersive and effective learning or training environment. In some implementations described herein, employee progress, mastery, and certification status are comprehensively monitored to provide valuable insights for management or supervisors within an organization. In some implementations, the virtual training assistant includes a modular, state-based architecture that allows for rapid updates to training content as regulations and requirements evolve.

By leveraging the capabilities of the virtual training assistant, companies and organizations can move beyond static, one-size-fits-all training methods and provide a more dynamic, personalized, and effective approach to compliance education and skills development.

The implementations described herein provide an adaptive generative AI assistant that is designed to provide a flexible and comprehensive training, certification, and compliance management solution. The virtual training assistant leverages a retrieval-augmented generation approach powered by a knowledge base. By combining custom instructions with an interactive conversational interface, the implementations described herein ensure that learners and employees can be effectively trained and assessed on various topics, including insurance, accreditation, cybersecurity, and more.

The virtual training assistant caters to individual users' learning styles and needs while ensuring compliance and training requirements are met. Retrieval-augmented generation is applied within the knowledge base for dynamic response and information retrieval. Robust security measures resist exploitation and ensure genuine progress tracking. Seamless versioning and update integration facilitates maintenance and ensures currency. The ability to track, record, and report on comprehensive metrics adds to the sophistication of the system described herein in an educational or professional setting.

In some implementations, the training assistant responds to and anticipates the evolving needs of users by incorporating practical performance feedback. The virtual training assistant leverages personal information of a user to effectively tailor the learning experience it provides and continuously improve the relevance and impact of the training content it outputs.

The techniques described herein may be used for corporate training, continuing education, and compliance management systems. The techniques described herein may also be used for customizing learning platforms in a variety of industries requiring strict adherence to standards and regulations. Additionally, the techniques described herein may be used for any scenario where adaptive education and accurate tracking of progression and mastery are essential.

Some of the potential applications for the techniques described herein may be in the educational technology (EdTech) market focusing on AI-driven Learning Management Systems (LMS); in corporate training solutions (particularly in sectors requiring regular compliance updates, such as finance, healthcare, and technology); and by government and institutional bodies seeking to implement automated, secure, and verifiable training programs.

The generative AI assistant has applications across domains where compliance is critical. The generative AI assistant's adaptive learning and dynamic content updates serve to bolster training and mastery in various compliance domains. For example, in the cybersecurity domain, the virtual training assistant generates simulations and interactive training modules focused on cybersecurity best practices. In the cybersecurity domain, the virtual training assistant equips users with the knowledge to recognize and avoid threats, such as phishing attacks, through real-time scenario-based learning.

In another example, the virtual training assistant may provide specialized content for educational institutions to ensure staff and faculty understand the Family Educational Rights and Privacy Act (FERPA) regulations. The assistant can track individual progress and ensure mastery of FERPA guidelines to protect student privacy.

In another example, the virtual training assistant may provide training covering Anti-Money Laundering (AML), Bank Secrecy Act (BSA), and Know Your Customer (KYC) protocols for the finance sector. Regular updates to the knowledge base are implemented as financial regulations evolve to maintain the relevance and currency of training materials.

In another example, the virtual training assistant may synthesize safety training across industries, such as Occupational Safety and Health Administration (OSHA) guidelines for manual handling, hazardous materials, and workplace safety protocols. Custom scenarios and assessments ensure that employees understand and can apply safety measures in their roles.

The virtual training assistant may provide training on General Data Protection Regulation (GDPR) for data handling and privacy, the Health Insurance Portability and Accountability Act (HIPAA) for health data protection, the Sarbanes-Oxley Act (SOX) for accounting and corporate governance, Americans with Disabilities Act (ADA) compliance for workplace accommodation and accessibility, the Equal Employment Opportunity Commission's (EEOC's) regulations to prevent workplace discrimination, corporate ethics and integrity programs, harassment and diversity training, environmental compliance and sustainability training, quality assurance and product compliance in manufacturing training, and the like.

The generative AI assistant ensures that these compliance trainings are not only covered and understood but also retained and applied by learners. The generative AI assistant is designed to validate a user's comprehension and mastery of these complex and constantly evolving topics, adapting the training content in real-time based on the learner's progression and real-world performance feedback. The broad applications of the implementations described herein across various compliance domains effectuates positive change in organizational compliance culture and individual behavioral adherence to regulations.

One example implementation provides a system for generative artificial intelligence based adaptive training. The system includes an electronic processor. The electronic processor is configured to receive a prompt to generate a virtual training assistant, the prompt including a description of one or more training aids and a format for responses corresponding to the one or more training aids. The electronic processor is also configured to retrieve, using a retrieval model, personnel information from a personnel database, retrieve, using the retrieval model, knowledge information corresponding to the personnel information from a knowledge database, and augment the prompt to include a compliance rule regulating responses of the virtual training assistant. The electronic processor is also configured to generate, using a generator model, the virtual training assistant based on the prompt and configured to generate responses corresponding to the personnel information, the knowledge information, the responses being in compliance with the compliance rule.

Another example implementation provides a method for generative artificial intelligence based adaptive training. The method includes receiving a prompt to generate a virtual training assistant, the prompt including a description of one or more training aids and a format for responses corresponding to the one or more training aids. The method also includes retrieving, using a retrieval model, personnel information from a personnel database, retrieving, using the retrieval model, knowledge information corresponding to the personnel information from a knowledge database, and augmenting the prompt to include a compliance rule regulating responses of the virtual training assistant. The method further includes generating, using a generator model, the virtual training assistant based on the prompt and configured to generate responses corresponding to the personnel information, the knowledge information, the responses being in compliance with the compliance rule.

### BRIEF DESCRIPTION OF THE DRAWINGS

FIG. 1 provides an example illustration of an electronic computing device for generative AI based adaptive training, in accordance with some implementations.

FIG. 2 provides an example illustration of components that the electronic computing device of FIG. 1 may communicate with, in accordance with some implementations.

FIG. 3 is a flowchart of an example method for generative AI based adaptive training, in accordance with some implementations.

FIG. 4 is a block diagram of an example graphical user interface displayed when a virtual training assistant is executed, in accordance with some implementations.

### DETAILED DESCRIPTION

Before any implementations are explained in detail, it is to be understood that the present disclosure is not limited in its application to the details of the configuration and arrangement of components set forth in the following description or illustrated in the accompanying drawings. The present disclosure is capable of other implementations and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, implementations may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one implementation, the electronic based aspects of the invention may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

Implementations are herein described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some aspects, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any example, feature, aspect, or implementation discussed in this specification can be implemented or combined with any part of any other example, feature, aspect, or implementation discussed in this specification.

Unless the context of their usage unambiguously indicates otherwise, the articles “a,” “an,” and “the” should not be interpreted as meaning “one” or “only one.” Rather, these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

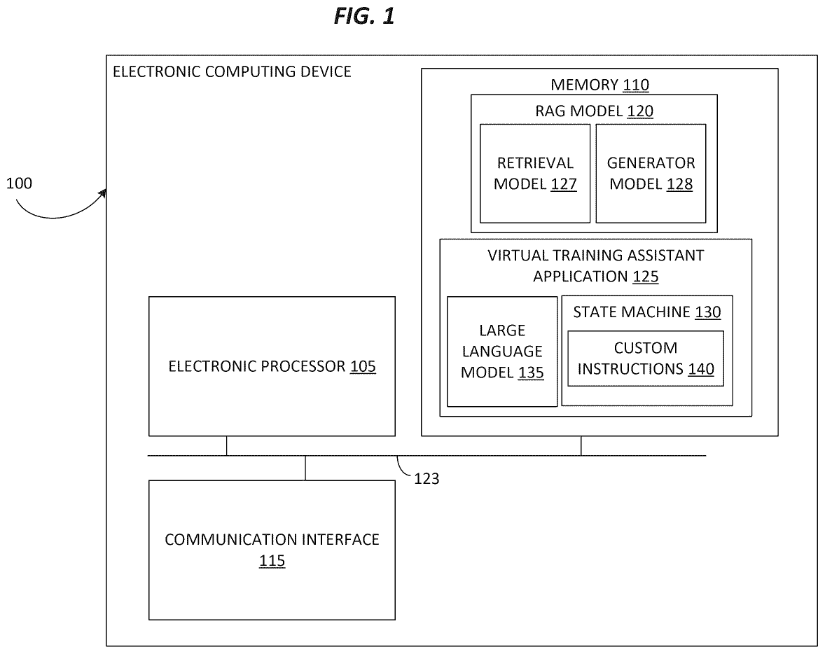

FIG. 1 provides an example illustration of an electronic computing device 100 (for example, a server) that is configured to implement one or more of the implementations described herein. The electronic computing device 100 may include an electronic processor 105 (for example, a microprocessor, application specific integrated circuit, a neural network processor (e.g., a deep neural network (DNN) processor, a convolutional neural network (CNN) processor, or the like), or the like), a memory 110, and a communication interface 115. The electronic processor 105, the memory 110, and the communication interface 115 may be electrically and communicatively coupled via a communication bus 123. FIG. 1 illustrates only one example of the electronic computing device 100. The electronic computing device 100 may include more or fewer components and may perform functions other than those explicitly described herein.

In some examples, the electronic processor 105 is implemented as a microprocessor with separate memory, such as the memory 110. In other examples, the electronic processor 105 may be implemented as a microcontroller (with memory 110 on the same chip). In other examples, the electronic processor 105 may be implemented using multiple processors. In addition, the electronic processor 105 may be implemented partially or entirely as, for example, a field-programmable gate array (FPGA), an applications specific integrated circuit (ASIC), an x86 processor, and the like and the memory 110 may not be needed or be modified accordingly. In some examples, the electronic processor may include a convoluted neural network (CNN), a deep neural network (DNN), or the like to execute machine learning models or artificial intelligence models.

In the example illustrated, the memory 110 includes non-transitory, computer-readable memory that stores instructions that are received and executed by the electronic processor 105 to carry out the implementations described herein. The memory 110 may include, for example, a program storage area and a data storage area. The program storage area and the data storage area may include combinations of different types of memory, such as read-only memory and random-access memory. The memory 110 may include one or more software modules including computer executable instructions that, when executed by the electronic processor 105, cause the electronic computing device 100 to perform a portion of the functionality described herein. For example, as illustrated in FIG. 1, the memory 110 may include a retrieval augmented generation (RAG) model 120 and a virtual training assistant 125. The RAG model 120 may include a retrieval model 127 and a generator model 128. The retrieval model 127 may be used by the electronic processor 105 to retrieve information (for example, information from one or more databases such as the personnel database and knowledge database described below) and the generator model 128 may be used by the electronic processor 105 to generate output based on the information retrieved by the retrieval model 127. In some implementations, knowledge information retrieved from the knowledge database by the retrieval model 127 may be combined using, for example, string aggregation prior to being sent to the generator model 128. In some implementations, the virtual training assistant 125 includes a state machine 130 and a large language model 135. In some implementations, one or more custom instructions 140 are associated with one or more of the plurality states of the state machine 130. Functionality described below as being performed by the RAG model 120, the virtual training assistant 125 (or the “assistant” or the “generative AI assistant”), the large language model 135, or the state machine 130, may in fact be performed by the electronic processor 105 when the electronic processor 105 executes the RAG model 120, the virtual training assistant 125, the large language model 135, or the state machine 130, respectively.

In some implementations, the electronic computing device 100 may include one electronic processor 105, and/or a plurality of electronic processors 105 in a cloud computer cluster arrangement, one or more of which may be executing none, all, or a portion of the applications or instructions of the electronic computing device 100 provided below, sequentially or in parallel across the one or more electronic processors 105. The one or more electronic processors 105 comprising the electronic computing device 100 may be geographically co-located or may be separated (for example, by miles), and interconnected via electronic and/or optical interconnects. One or more proxy servers or load balancing servers may control which one or more electronic processors 105 perform any part or all the applications provided below.

The electronic processor 105 may be configured to send and receive information from one or more communication networks (for example, a Wi-Fi network, a Bluetooth™ network, and the like) via the communication interface 115. The communication interface 115 may include, for example, a transceiver or a transmitter and receiver.

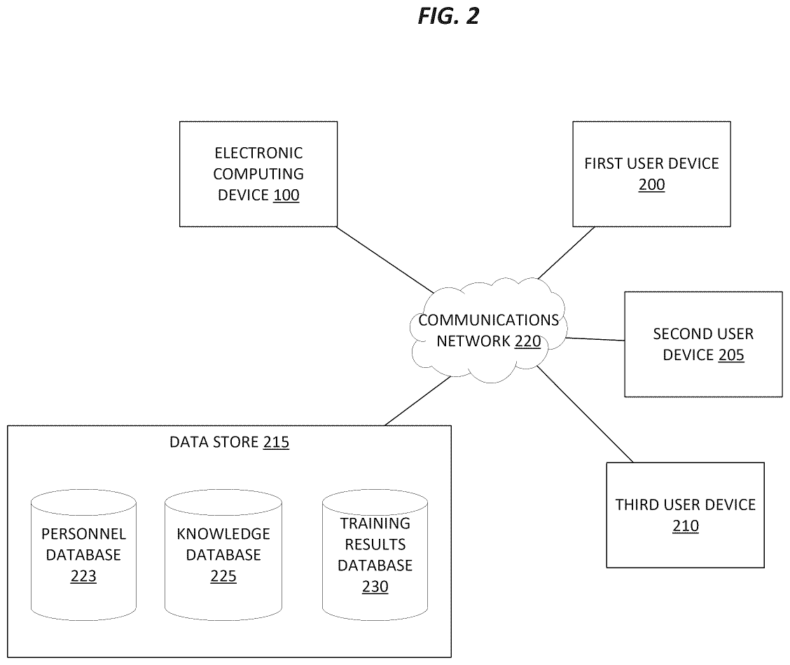

As illustrated in FIG. 2 the electronic computing device 100 may communicate with one or more user devices (for example, a first user device 200, a second user device 205, and a third user device 210) and a data store 215 via a communications network 220. The user devices 200, 205, 210 may be personal computers, cell phones, smart phones, laptop computers, a combination of the foregoing, and the like. The user devices 200, 205, 210 may each include an electronic processor, memory, and communication interface that are similarly configured to the electronic processor 105, the memory 110, and the communication interface 115 of the electronic computing device 100. Additionally, the user devices 200, 205, 210 may each include a user interface that includes one or more input and/or output devices (for example, a screen or a touchscreen on which a user interaction interface may be displayed). The user interface included in each of the user devices 200, 205, 210 may be electrically and communicatively coupled to the electronic processor, memory, and communication interface included in each of the user devices 200, 205, 210, respectively, via a communication bus. The data store 215 or data storage system may be, for example, one or more databases or other electronic computing devices suitable for data storage and retrieval. In some implementations, the data store 215 is a cloud-based repository. In some implementations, the data store 215 includes a personnel database 223, a knowledge database 225, and a training results database 230. In some implementations, the knowledge database 225 includes a plurality of documents relating to training modules. In some implementations, the documents included in the knowledge database 225 are divided into searchable embeddies. The number of components included in FIG. 2 is purely illustrative. For example, the electronic computing device 100 may be in communication with a different number of user devices than the number of user devices included in FIG. 2.

In some implementations, the communications network 220 is a communications network including wireless connections, wired connections, or combinations of both. The communications network 220 may be implemented using a wide area network, for example, the Internet, a Long-Term Evolution (LTE) network, a 4G network, a 5G network and one or more local area networks, for example, a Bluetooth™ network or Wi-Fi network, and combinations or derivatives thereof.

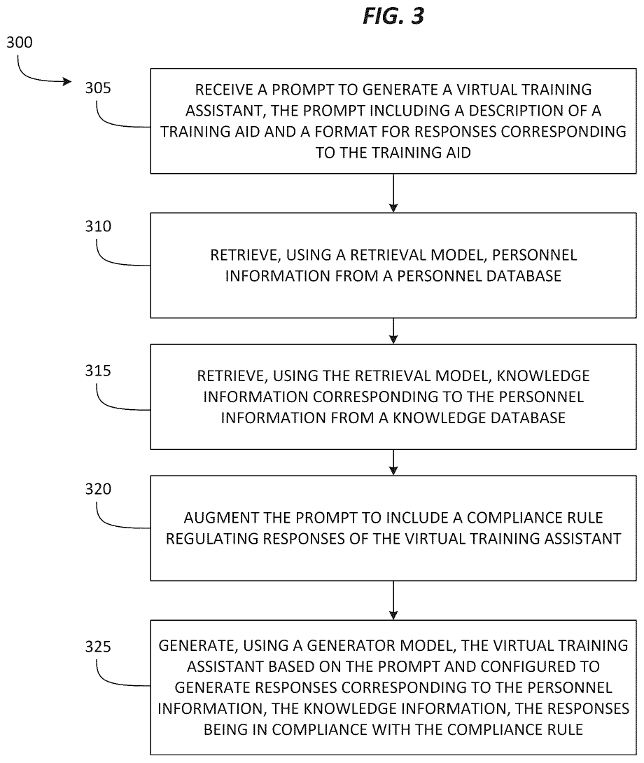

FIG. 3 is a flowchart of a method 300 for generative AI based adaptive training. In some implementations, the method 300 begins when a user accesses an application (for example, a web application) via a user device (for example, via the user interface of the first user device 200). In some implementations, the user enters log-in credentials (for example, a username and password) into the application via the user interface and the first user device 200 sends the log-in credentials to the electronic computing device 100. The electronic computing device 100 (specifically, the electronic processor 105) receives the log-in credentials and authenticates the user using the log-in credentials entered by the user.

In some implementations, once the user is authenticated, the user may interact with the RAG model 120 (an assistant creator) to create a virtual training assistant (for example, the virtual training assistant 125). In some implementations, at block 305, the electronic processor 105 receives a prompt to generate a virtual training assistant. In some implementations, the prompt includes a description of a training aid and a format for response corresponding to the training aid. For example, the prompt includes a format for a response generated by a virtual training assistant when the virtual training assistant utilizes the training aid.

In some implementations, the prompt may include a description of the format for the response based on the training aid or an identifier of the format for the response based on the training aid. In some implementations, the format defines how parameters are passed to the training aid.

In some implementations, the description of the training aid may include a description of a tool (for example, a name of or identifier for a tool) or a description of an action. In some implementations, tools may allow a virtual training assistant to generate different kinds of content (for example, flashcards, educational games, and the like), log or send a record of training progress of a user to the training results database 230, call another virtual training assistant (for example, a previously generated virtual training assistant that specializes in providing a type of training different from the type of training provided by the virtual training assistant 125), a tool for changing states in a state machine (for example, the state machine 130), a tool for retrieving knowledge information from a knowledge database 225, or the like. A query tool may allow a virtual training assistant to request one selected from the group consisting of training material, quiz material, and the compliance rule from one or more databases. For example, a virtual training assistant may utilize the query tool to retrieve training material and quiz material from the knowledge database 225. In some implementations, the training aids may be included in an electronic computing device other than the electronic computing device 100 and the electronic processor 105 may access the training aids through one or more application programming interfaces (APIs).

In some implementations, the user enters the prompt via a chat interface displayed in a web application via the user interface of the first user device 200 and the first user device 200 may send the prompt to the electronic processor 105. In some implementations, the prompt may be received on the first user device 200 or from a first user profile on any user device to generate the virtual training assistant. In some implementations, the generated virtual training assistant is available for use on other user devices (e.g., the second user device 205 and the third user device 210) or with other user profiles. The first user device 200 and/or the first user profile may belong to an administrator and the other user devices and/or user profiles may belong to personnel that are the target of adaptive training.

In some implementations, at block 310, the electronic processor 105 retrieves, using a retrieval model (for example, the retrieval model 127), personnel information from a personnel database (for example, the personnel database 223). As described above, the electronic processor 105 receives login credentials from a user. In some implementations, based on the login credentials, the electronic processor 105 may determine personnel information associated with the user (for example, an education level associated with a user, a job title associated with the user, a user's previously completed trainings, a combination of the foregoing, and the like). In some implementations, the electronic processor 105 determines personnel information associated with a user by querying the personnel database 223 using the user's login credentials.

In some implementations, at block 315, the electronic processor 105 retrieves, using the retrieval model 127, knowledge information corresponding to the personnel information from a knowledge database 225. For example, the electronic processor 105 may retrieve one or more documents from the knowledge database 225 that are relevant to training the user on a topic based on the user's personnel information. For example, the when the user works in finance and is being trained on the topic of secure handling of client information, the knowledge information retrieved from the knowledge database 225 may include one or more documents on privacy regulations regarding financial data. In another example, the when the user works in healthcare and is being trained on the topic of secure handling of patient information, the knowledge information retrieved from the knowledge database 225 may include one or more documents on privacy regulations regarding patient healthcare information.

In some implementations, at block 320, the electronic processor 105 augments the prompt to include a compliance rule regulating responses of the virtual training assistant. In some implementations, the electronic processor 105 augments the prompt to include a plurality of compliance rules.

In some implementations, at block 325, the electronic processor 105 generates, using a generator model (for example, the generator model 128), the virtual training assistant (for example, the virtual training assistant 125) based on the prompt (specifically, the prompt that has been augmented to include the compliance rule). The virtual training assistant is configured to generate responses corresponding to the personnel information and the knowledge information. In some implementations, the responses generated by the virtual training assistant are in compliance with the compliance rule. In some implementations, the electronic processor 105 checks or determines whether one or more responses generated by the virtual training assistant 125 are in compliance with the compliance rule by inputting, to a generative artificial intelligence model that is not included in the virtual training assistant 125, a prompt including a conversation history between a user and the virtual training assistant 125. The conversation history included in the prompt includes at least one response generated by the virtual training assistant 125. In some implementations, the conversation history included in the prompt includes at least one response generated by the virtual training assistant 125 and natural language input from a user. The compliance rule ensures that the responses generated by the virtual training assistant 125 comply with requirements for training a user on a selected topic (for example, requirements that must be met for a user to achieve a certification). The virtual training assistant may be generated as a separate application that can be instantiated on each user device 200, 205, 210, or for each user profile.

In some implementations, as a part of generating the virtual training assistant 125, the electronic processor 105 using the RAG model 120, generates a state machine (for example, the state machine 130) including a plurality of states based on the prompt. The states of the state machine may relate to different modules or chapters in a training program, different phases of the training program (e.g., learning phase, testing phase, etc.), and the like. The states of the state machine may be automatically generated by the RAG model 120. In one example, the RAG model 120 may use a pre-stored template to generate the states of the state machine.

In some implementations, the electronic processor 105, executing the RAG model 120, may generate a natural language output prompting the user for one or more custom instructions based on the received prompt. In some implementations, the electronic processor 105 receives one or more custom instructions from the user via, for example, the first user device 200 when the user enters the one or more custom instructions into a text field in a graphical user interface. Examples of custom instructions may include “generate a game to teach about phishing” and “provide anecdotal examples for each topic.” The electronic processor 105 may determine whether the one or more custom instructions received from the user are compatible with the compliance rule(s). When the one or more custom instructions received from the user are compatible with the compliance rule, the electronic processor 105 associates the one or more custom instructions with one or more states in the state machine 130. The compliance rule(s) may be provided to prevent a user from cheating when taking a training test.

In some implementations, the user may indicate (via, for example, a natural language input) that the user wishes the electronic processor 105 to generate all or some custom instructions. In these implementations, the electronic processor 105 for at least one state of the plurality of states, generates, using the RAG model 120, one or more custom instructions associated with the at least one state based on the prompt. As described above, in some implementations, the electronic processor 105 determines training aids(s) and knowledge information based on the prompt as well as determines compliance rule(s). The electronic processor 105 may generate the one or more custom instructions (for example, the custom instructions 140) for one or more of the plurality of states based on the compliance rule(s), one or more training aid(s), and knowledge information.

In some implementations, the electronic processor 105 determines one or more custom instructions based on the user. In some implementations, the electronic processor 105 uses the personnel information associated with the user to tailor the state machine 130 to the user by generating one or more custom instructions based on the personnel information associated with the user.

In some implementations the electronic processor 105 generates the virtual training assistant (for example, the virtual training assistant 125) for providing an adaptive training experience using the state machine (for example, the state machine 130) and a large language model (for example, the large language model 135).

In some implementations, the electronic processor 105, when executing the virtual training assistant 125, receives a natural language input from a user and generates a response based on the input using the virtual training assistant 125. In some implementations, when the electronic processor 105 generates output based on the input using the virtual training assistant 125, the electronic processor 105 determines a current state of the state machine 130 and generates the output by executing the large language model 135 in accordance with the one or more custom instructions associated with the current state of the state machine 130. In some implementations, when the large language model 135 (for example, a RAG model) is executed by the electronic processor 105, the output generated by the large language model 135 is based on the natural language input from the user and data included in the knowledge database 225.

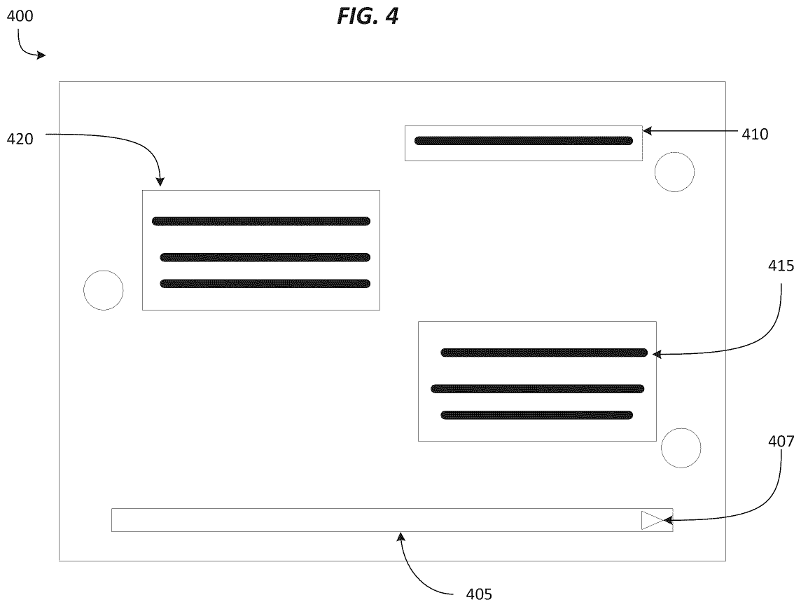

FIG. 4 provides an example graphical user interface (GUI) 400 that may be displayed via a user interface of a user device (for example, the first user device 200) when the virtual training assistant 125 is executed by the electronic processor 105. The GUI 400 includes a text field 405 where a user may enter natural language input. When a user submits a natural language input to send to the electronic processor 105 (for example, by selecting an icon 407), the natural language input may be displayed in the GUI 400. For example, text boxes 410 and 415 may include natural language input previously submitted by a user. Based on the natural language input, the electronic processor 105, executing the virtual training assistant 125, generates output based on the natural language input. The output generated based on the natural language input may be displayed in the GUI. For example, the text box 420 includes output generated based on the natural language input included in the text box 410. The content included in the text boxes 410, 415, and 420 may part of a conversation history.

In some implementations, the output generated by the electronic processor 105 when executing the virtual training assistant 125 may be a conversational response or a content response. For example, a conversational response may include a natural language response to a natural language question or statement from a user. A content response may include learning materials such as flashcards, quiz questions, interactive simulations, or the like. In some implementations, the virtual training assistant 125 may utilize one or more tools to generate a content response.

In some implementations, the electronic processor 105 may update the custom instructions associated with one or more states of the state machine 130 based on user input received when the electronic processor 105 is executing the virtual training assistant 125. In some implementations, custom instructions created by the electronic processor 105 based on the user input are compatible with the compliance rule(s). For example, if the electronic processor 105 receives the user input “highlight correct quiz answers,” the electronic processor 105 will not create a custom instruction based on the user input if a user is required to answer quiz questions correctly to complete their training. When the virtual training assistant is generated, a compliance module may also be generated that operates in the background to monitor the interaction between the virtual training assistant and the user. The compliance module may generate an interrupt when a user input may result in incompatibility with the compliance rules. The compliance module moderates the output of the virtual training assistant for such user inputs.

In some implementations, the electronic processor 105 may update the custom instructions associated with one or more states included in the state machine 130 when the knowledge information included in the knowledge database 225, the personnel information of the user included in the personnel database 223, the compliance rule(s), the training aid(s), a combination of the foregoing, or the like are updated.

In some implementations, the electronic processor 105 determines a current state of the state machine 130 and, based on the current state of the state machine 130, determines progress made by a user. In some implementations, the electronic processor 105 sends the progress made by the user to the training results database 230 to be logged in the training results database 230.

In some implementations, the virtual training assistant 125 is stored in the memory 110 after a user has logged out of the application and may be re-accessed by the user when the user logs in to the application again at a later time.

In some implementations, the state machine 130 allows the virtual training assistant 125 to be governed by different custom instructions depending on the current state of the state machine 130. Being governed by difference custom instructions depending on the current state of the state machine 130 is in allows the large language model 135 to access different knowledge information in the knowledge database 225, use different training aids, and adapt its behavior depending on the state of the state machine 130. Additionally, the flexibility provided by the state machine 130 may allow the virtual training assistant 125 to access different training aids to enhance the learning experience of a user depending on the user's progress and needs.

In some implementations, the state machine 130 transitions between states based on inputs from a user, learning progress made by a user, or a predefined criterion. As noted above, each state of the state machine 130 corresponds to a set of custom instructions. The custom instructions may be used by the large language model 135 to tailor its output (for example, conversational responses and content responses) to the specific needs of the current state of the state machine 130. In some implementations, the custom instructions guide the large language model 135 on how to interact with the user/learner, what documents or knowledge information in the knowledge database 225 to reference when generating output, and which specific retrieval-augmented processes to perform when generating output. In some implementations, varying custom instructions based on the state that the state machine 130 is in ensures that prompts generated by the virtual training assistant 125 and teaching strategies implemented by the virtual training assistant 125 remain relevant and effective.

In some implementations, the electronic processor 105, executing the virtual training assistant 125, selectively accesses different knowledge information included in the knowledge database 225 depending on the state that the state machine 130 is in, focusing on material that aids in achieving the learning objectives of the state that the state machine 130 is in. For example, as a learner/user progresses through the states of the state machine 130, the virtual training assistant 125 retrieves more complex or in-depth information from the knowledge database 225 to generate, using the large language model 135, content that challenges the user/learner appropriately.

In some implementations, the tools that the virtual training assistant 125 may access varies depending on the state that the state machine 130 is in. For example, in some states, the virtual training assistant 125 may access contextually relevant learning tools that may be used by the large language model 135 to generate interactive content such as games, simulations, virtual labs, creative platforms, or the like. For example, an ‘Application State’ might offer simulation tools for generating practical exercises, while a ‘Review State’ could provide the virtual training assistant 125 access to quiz generator tools and flashcard generator tools.

In some implementations, in certain states of the state machine 130, the virtual training assistant may access one or more tools for tracking progress of a user/learner. In some implementations, parameters for mastery and completion of a learning module associated with a state are defined within by the state's custom instructions. In some implementations, the electronic processor 105 is configured to generate visual dashboards to be displayed via a graphical user interface of a user device (for example, the user interface of the first user device 200). In some implementations, visual dashboards are updated in real-time to reflect the user/learner's achievements and progress through the states of the state machine 130.

In some implementations, the custom instructions associated with a state of the state machine 130 define guard rails to ensure content and conversation generated by the large language model 135 are output to a user in a structured manner, ensuring a sequential exploration of topics if necessary for, for example, comprehension or compliance reasons. For example, in compliance-focused states of the state machine 130, the guide rails implemented by the custom instructions may require certain topics to be addressed in a specific order before advancing (for example, before moving the state machine 130 to a next state). For example, the electronic processor 105 may receive an ordered list of required concepts and, utilizing a training aid, the virtual training assistant 125 may provide training on the required concepts or topics in the order specified in the ordered list. In some implementations, the electronic processor 105 documents when training has been provided by the virtual training assistant 125 on a required concept. In some implementations, the electronic processor 105 tracks a user's mastery of material through these assessments and interactive modules, ensuring that all required areas are understood by a user before advancing to the next state in the state machine 130.

In some implementations, the electronic processor 105 determines when a transition between states is required. For example, moving from a state associated with a beginner learning module to a state associated with an intermediate learning module may be required or allowed after the user successfully completes one or more assessments generated by the large language model 135 when the state machine 130 is in the state associated with the beginner learning module. In some implementations, the electronic processor 105 implements one or more security protocols to prevent unauthorized state transitions and ensure the integrity of user progress and the evaluation of mastery.

In some implementations, each state of the state machine 130 may be versioned and updated independently of every other state of the state machine 130 to accommodate changes in material included in the knowledge database 225, learning methods, compliance requirements, tools, a combination of the foregoing, or the like. Updating a state may include updating the custom instructions associated with the state. Updating states ensures that users/learners always encounter up-to-date and relevant content for the state that the state machine 130 is in.

By adopting a state-based design, the generative AI assistant unlocks a versatile range of teaching strategies, learning tools, and levels of content depth that can evolve with the user's growing expertise, thereby creating a more personalized, effective, and engaging learning/training experience for a user. While the states of the state machine 130 provide a structure to the training experience, customization via custom instructions 140 ensures that individual learning styles and preferences are catered to within each state of the state machine 130. Customization enhances user engagement and the efficacy of the virtual training assistant 125.

The virtual training assistant 125 has a unique capability to synthesize a variety of educational information including specialized topics and create a variety of content (for example, assessment materials, games, other interactive content, or the like) designed to teach or train users. This functionality of the virtual training assistant 125 enriches the learning environment that the virtual training assistant 125 can provide to a user and ensures that a user gains comprehensive understanding of the educational information presented by the virtual training assistant 125.

For example, using the large language model 135, the virtual training assistant 125 may converse with a user to understand the user's learning objectives. The virtual training assistant 125 may create personalized quizzes, tests, and assessments for the user based on information received from the user regarding the user's learning objectives. Assessments may be generated by the large language model 135 using content retrieved from the knowledge database 225 and related to the topics being assessed, thus, ensuring relevance and accuracy.

In another example, the virtual training assistant 125, using the large language model 135, creates educational games that reinforce learning objectives associated with a state of the state machine 130 in a playful manner. In some implementations, the large language model 135 tailors the games to the proficiency level of the user and adapts the games as the user progresses in their understanding of the material being taught by the virtual training assistant 125.

In yet another example, the virtual training assistant 125, using the large language model 135, creates interactive scenarios that users can navigate, promoting experiential learning. These scenarios may include role-play exercises or simulations that are pertinent to the topic being taught in the state that the state machine 130 is in and enhance the user's applied knowledge.

In some implementations, the virtual training assistant 125, using the large language model 135, creates comprehensive learning modules on various topics by integrating different materials from the knowledge database 225. The virtual training assistant's 125 ability to adaptively generate output based on user responses ensures that users remain engaged and benefit from a learning experience that is responsive to their needs.

In some implementations, the electronic processor 105 tracks and confirms whether a user has achieved a mastery of a topic necessary for earning a certification or accreditation in that topic. For example, the electronic processor 105 may assess a user's mastery of a topic based on a user's assessment scores and what topics a user has completed. In some implementations, when training a user on a particular training topic, the electronic processor 105 periodically generates an assessment for the training topic. In some implementations, the electronic processor 105 receives input from a user (via, for example, the first user device 200) in response to an assessment generated by the virtual training assistant 125 and, based on the received input, determines a score. The score may represent the knowledge of the user regarding the training topic. In some implementations, the virtual training assistant adjusts its responses based on the score. For example, if the user achieves a low score on a training topic (for example, spotting phishing e-mails) the virtual training assistant 125 may generate responses that stress the correct ways to identify phishing emails. In some implementations, what topics a user has completed may be determined based on what state the state machine 130 is in. In some implementations, a user's assessment scores and what topics a user has completed may be stored in the memory 110. The electronic processor 105 may check if criteria for achieving a certificate or accreditation or completing training have been met, and when criteria for achieving a certificate or accreditation or completing a training have been met, the electronic processor 105 may log the achievement of a certificate or accreditation into the training results database 230. In some implementations, the electronic processor 105 checks or determines whether criteria for achieving a certificate or accreditation or completing training have been met by inputting, to a generative artificial intelligence model that is not included in the virtual training assistant 125, a prompt including a conversation history between a user and the virtual training assistant 125. The training results database 230 may track the progress of users against their goals and provide users insights into their training completions and the learning journey. In some implementations, the electronic processor 105 may generate detailed records of a user's progress through games and assessments to provide insights into the user's mastery of concepts and the user's engagement.

In some implementations, the electronic processor 105 generates dashboards and/or portals showing a user's progress towards completing certifications, training, or other learning objectives. Such dashboards and/or portals may be sent to a user device (for example, the first user device 200) for display via a user interface. In some implementations, records and reports or user achievement and progress are maintained seamlessly in the training results database 230 for administrative oversight.

In some implementations, the electronic processor 105 creates a long-term learning profile for a user. A long-term learning profile may track a user's growth, challenges, and strengths. In some implementations, the virtual training assistant 125 uses the long-term learning profile generated for a user to proactively adjust future content and recommendations that the virtual training assistant 125 provides to the user. In some implementations, the electronic processor 105 may utilize long-term learning profiles to prompt users to explore new areas pertinent to their job role evolution or to anticipate future industry trends.

In some implementations, the electronic processor 105 prevents prompt injection attacks and ensures the integrity of learner responses. For example, the electronic processor 105 may generate multiple varied prompts to secure the validity of user responses using a consensus mechanism.

In some implementations, techniques to prevent gaming of the virtual training assistant 125 or manipulation of the assessments are implemented by the electronic processor 105 to maintain the integrity of the learning process. Advanced security measures may be utilized by the electronic processor 105 to ensure that the instructional materials, interactive content, and generated assessments cannot be corrupted or biased. This advanced synthesis of assessment materials and interactive content offers learners a more dynamic, personalized, and enjoyable learning experience while maintaining the robustness and reliability required for professional training and accreditation purposes.

In the implementations described herein, the real-world performance tracking performed respects user privacy and adheres to data security standards. In some implementations, actions (for example, updates to the knowledge database 225) triggering updates to a virtual training assistant 125 undergo a rigorous verification process to ensure that the input is accurate and represents a valid educational opportunity rather than an anomaly or outlier.

In some implementations, different versions of the virtual training assistant 125 may be created by the electronic processor 105 to cater to diverse curricula or updates to content included in the knowledge database 225. Creating different versions of the virtual training assistant 125 ensures that the assessments, games, and other output generated by the assistant remains current and effective. One of various versions of an assistant may be deployed as per certification updates or production changes.

In some implementations, the electronic processor 105 is configured to personalize the virtual training assistant 125 to the user that is logged into the application. For example, the virtual training assistant may automatically adjust the output it produces to focus on areas where a user has shown weaknesses (for example, a susceptibility to phishing attacks). In the case of repeat infractions by a user in a particular area (for example, repeatedly selecting links included in phishing emails), the virtual training assistant 125 may focus the training content it produces on the particular area the user is struggling in (for example, identifying phishing attempts) and may produce more stringent assessments or simulations to reiterate the importance of compliance in these areas.

In some implementations, the virtual training assistant 125 incorporates performance metrics and outcomes into learning algorithms, allowing the virtual training assistant 125 to recognize patterns suggesting broader training needs or that revisions to training curriculum/content are desired. Feedback regarding one or more users' job performance can trigger automated revisions of training materials, ensuring that training materials are not just theoretically sound, but also practically applicable. In some implementations, the virtual training assistant 125 is designed to receive input regarding a user's practical performance within their career environment (for example, incidents involving security breaches or safety violations by the user). The virtual training assistant 125 may, based on the input regarding a user's practical performance within their career environment, dynamically update the instructional content generated to address any deficiencies or misconceptions evidenced by the real-world actions taken by the user.

In some implementations, the virtual training assistant 125 may use data regarding a user's educational background, interests, job role, and the like to create content that is more relatable and effective for the user. For example, the virtual training assistant 125 may generate an explanation of a concept that uses analogies drawn from the user's areas of interest, job function, prior knowledge, or the like to enhance the comprehension and retention of the user.

In some implementations, depending on a user's professional level and role, the electronic processor 105 may adjust the virtual training assistant 125 to offer a customized learning curve that suits the career stage and responsibilities of the user. The virtual training assistant 125 may use sophisticated natural language understanding to tailor its output to the vocabulary and comprehension level appropriate given the user's education and expertise. In some implementations, the electronic processor 105 adapts the virtual training assistant 125 to a user's pace and preference in learning material.

In some implementations, the virtual training assistant provides a conversational interface that guides users through material with natural, human-like interactions. In some implementations, the electronic processor 105 adapts or resets a conversation history to align the conversation history with the user's learning journey. In some implementations, the large language model 135 utilizes starting points in conversation histories to enhance a user's interactive learning experience until the conversation reaches a natural end or a ‘completion point’ determined by the large language model 135.

What is claimed is:

1. A system for generative artificial intelligence based adaptive training, the system comprising:
an electronic processor configured to:
receive a prompt to generate a virtual training assistant, the prompt including a description of one or more training aids and a format for responses corresponding to the one or more training aids;
retrieve, using a retrieval model, personnel information from a personnel database;
retrieve, using the retrieval model, knowledge information corresponding to the personnel information from a knowledge database;
augment the prompt to include a compliance rule regulating responses of the virtual training assistant; and
generate, using a generator model, the virtual training assistant based on the prompt and configured to generate responses corresponding to the personnel information, the knowledge information, the responses being in compliance with the compliance rule.

2. The system according to claim 1, wherein the virtual training assistant is based on large language model and wherein the electronic processor is further configured to:
implement a state machine including a plurality of states, each state of the plurality of states associated with one or more custom instructions for generating responses using the virtual training assistant.

3. The system according to claim 1, wherein the format defines passing of parameters to the one or more training aids.

4. The system according to claim 1, wherein the one or more training aids includes a query tool and wherein the electronic processor is configured to request, using the query tool, one selected from the group consisting of training material, quiz material, and the compliance rule.

5. The system according to claim 1, wherein the electronic processor is further configured to:
periodically generate an assessment for a training topic using the virtual training assistant,
receive input from a user in response to the assessment;
generate a score based on the received input, wherein the score represents knowledge of the user regarding the training topic;
adjust responses of the virtual training assistant based on the score;
determine training progress of the user based on the score; and
store a record of the training progress of the user in a training results database.

6. The system according to claim 1, wherein the electronic processor is further configured to:
determine whether training criteria have been met by inputting, to a generative artificial intelligence model separate from the virtual training assistant, a prompt including a conversation history between a user and the virtual training assistant.

7. The system according to claim 1, wherein the electronic processor is further configured to:
determine whether a response generated by the virtual training assistant is in compliance with the compliance rule by inputting, to a generative artificial intelligence model separate from the virtual training assistant, a prompt including the response generated by the virtual training assistant.

8. The system according to claim 1, wherein the electronic processor is further configured to:
receive an ordered list of training topics; and
using, via the virtual training assistant, the one or more training aids provide training on the training topics in the order of the ordered list; and
store training progress of the ordered list for a user in a training results database.

9. The system according to claim 1, wherein the electronic processor is further configured to:
receive login credentials from a user; and
retrieve, using a retrieval model, personnel information from a personnel database based on the login credentials.

10. The system according to claim 1, wherein the one or more training aids includes at least one selected from a tool instantiating a second virtual training assistant, a tool changing states in a state machine corresponding to the virtual training assistant, and a tool retrieving knowledge information from a knowledge database.

11. A method for generative artificial intelligence based adaptive training, the method comprising:
receiving a prompt to generate a virtual training assistant, the prompt including a description of one or more training aids and a format for responses corresponding to the one or more training aids;
retrieving, using a retrieval model, personnel information from a personnel database;
retrieving, using the retrieval model, knowledge information corresponding to the personnel information from a knowledge database;
augmenting the prompt to include a compliance rule regulating responses of the virtual training assistant; and
generating, using a generator model, the virtual training assistant based on the prompt and configured to generate responses corresponding to the personnel information, the knowledge information, the responses being in compliance with the compliance rule.

12. The method according to claim 11, wherein the virtual training assistant is based a large language model, the method further comprising:
implementing a state machine including a plurality of states, each state of the plurality of states associated with one or more custom instructions for generating responses using the virtual training assistant.

13. The method according to claim 11, wherein the format defines passing of parameters to the one or more training aids.

14. The method according to claim 11, wherein the one or more training aid includes a query tool, the method further comprising requesting, using the query tool, one selected from the group consisting of training material, quiz material, and the compliance rule.

15. The method according to claim 11, further comprising:
periodically generating an assessment for a training topic using the virtual training assistant,
receiving input from a user in response to the assessment;
generating a score based on the received input, wherein the score represents knowledge of the user regarding the training topic;
adjusting responses of the virtual training assistant based on the score;
determining training progress of the user based on the score; and
storing a record of the training progress of the user in a training results database.

16. The method according to claim 11, further comprising:
determining whether training criteria have been met by inputting, to a generative artificial intelligence model separate from the virtual training assistant, a prompt including a conversation history between a user and the virtual training assistant.

17. The method according to claim 11, further comprising:
determining whether a response generated by the virtual training assistant is in compliance with the compliance rule by inputting, to a generative artificial intelligence model separate from the virtual training assistant, a prompt including the response generated by the virtual training assistant.

18. The method according to claim 11, further comprising:
receiving an ordered list of training topics; and
using, via the virtual training assistant, the one or more training aids
providing training on the training topics in order of the ordered list; and
storing training progress of the ordered list for a user in a training results database.

19. The method according to claim 11, further comprising:
receiving login credentials from a user; and
retrieving, using a retrieval model, personnel information from a personnel database based on the login credentials.

20. The method according to claim 11, wherein the one or more training aids includes at least one selected from a tool instantiating a second virtual training assistant, a tool changing states in a state machine corresponding to the virtual training assistant, and a tool retrieving knowledge information from a knowledge database.
